(19) United States
(12) Patent Application Publication
(10) Pub. No.: US 2021/0097578 A1
(43) Pub. Date: Apr. 1, 2021

(54) MARKETING AUTOMATION PLATFORM

(71) Applicant: JJG Development, LLC, DBA Smart Pickle, Portland, OR (US)

(72) Inventors: John A. Holmes, Portland, OR (US); Gabriel Winslow, Oregon City, OR (US); Edward Rafaele, Portland, OR (US)

(21) Appl. No.: 17/061,202

(22) Filed: Oct. 1, 2020

Related U.S. Application Data
(60) Provisional application No. 62/909,034, filed on Oct. 1, 2019.

(51) Int. Cl. G06Q 30/02; G06Q 10/10; G06Q 30/00; G06Q 20/20; G06Q 50/00; G06Q 10/08; G06N 20/00

(52) U.S. Cl. CPC G06Q 30/0269; G06Q 10/10; G06Q 30/016; G06Q 30/0201; G06Q 30/0276; G06N 20/00; G06Q 20/202; G06Q 30/0246; G06Q 30/0247; G06Q 50/01; G06Q 10/087; G06Q 30/0264

(57) ABSTRACT

A digital marketing automation system includes a server including a processor. The processor is configured to, in a data collection phase, after an initializing command from a user receive business information of the user from websites, receive customer information from point of sales systems, and generate a customer database of selectable customers. The processor is configured to, in a connection phase, receive input designating services utilized by the user for customer interactions, connect data input from the point of sales systems and services for customer interactions as customer engagement data and store the customer engagement data in a customer database, and receive continuous customer engagement data. The processor is configured to, in a building phase, receive input specifying at least one available product or service of the business, generate customized offers, and generate a promotional schedule for promotional material including the customized offers to be sent to the selectable customers.

### CROSS-REFERENCE TO RELATED APPLICATIONS

This application claims the benefit of U.S. provisional patent application No. 62/909,034, filed Oct. 1, 2019 and entitled MARKETING AUTOMATION PLATFORM, the entire disclosure of which is hereby incorporated herein by reference for all purposes.

### BACKGROUND

Marketing and promotion plays an important role in communicating the product and service offerings of a business to its potential customers. Businesses engage in marketing activities to attract both new and repeat customers, with the goal of increasing demand for their products and services. In addition to print media, radio, and television, the advent of the Internet has introduced new marketing channels, such as email, banner ads, sponsored search results, and sponsored social media posts. With the emergence of these channels, the technical complexity of running an effective marketing and promotion campaign has increased. A challenge exists in providing a technical platform to address these complexities.

### SUMMARY

To address these issues, a digital marketing automation system is provided. The system may include a server including a processor and associated storage; the processor may be configured to execute instructions stored in the associated storage. The processor may be configured to, in a data collection phase: after receiving an initializing command from a user, create a user account and receive, for a business of the user, business information from available websites and online images; receive customer information from one or more point of sales systems of the user; and from the customer information, generate a customer database of selectable customers. The processor may be configured to, in a connection phase: receive input designating services utilized by the user for customer interactions; connect data input from the one or more point of sales systems and from the designated services utilized by the user for customer interactions as customer engagement data and store the customer engagement data in the customer database; and receive continuous customer engagement data from the connected data input to the customer database.

The processor may be configured to, in a building phase: receive input specifying at least one available product or service of the business of the user; generate customized offers to be sent to the selectable customers based at least on the business information; and based on the at least one available product or service, generate a promotional schedule for a predetermined period of time for promotional material including the customized offers to be sent to the selectable customers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 shows a digital marketing automation system according to an example implementation of the present disclosure.

FIG. 2 shows a digital marketing automation website page for a user account according to one example implementation of the system of FIG. 1.

FIG. 3 shows a digital marketing automation website page for promotion creation according to one example implementation of the system of FIG. 1.

FIG. 4 shows a digital marketing automation website page for promotion customization according to one example implementation of the system of FIG. 1.

FIG. 5 shows a digital marketing automation website page for promotion creation by cuisine according to one example implementation of the system of FIG. 1.

FIG. 6 shows a digital marketing automation website page for promotion type selection according to one example implementation of the system of FIG. 1.

FIG. 7 shows a digital marketing automation website page for importing customers to the system according to one example implementation of the system of FIG. 1.

FIG. 8 shows a digital marketing automation website page for connecting customers according to one example implementation of the system of FIG. 1.

FIGS. 9A-9C shows a digital marketing automation website pages for designation of available service periods according to three different example implementations of the system of FIG. 1, for a restaurant, an automotive service facility, and a childcare provider.

FIG. 10 shows a digital marketing automation website page for setting terms and conditions according to one example implementation of the system of FIG. 1.

FIG. 11 shows a digital marketing automation website page including a promotional schedule according to one example implementation of the system of FIG. 1.

FIG. 12 shows a customer device displaying a deployed promotion according to one example implementation of the system of FIG. 1.

FIG. 13 shows a digital marketing automation website page including a dashboard of the account of the user according to one example implementation of the system of FIG. 1.

FIG. 14 is a schematic of training, input, and output of a machine learning system for an example implementation of the digital marketing automation system.

FIG. 15 shows the digital marketing automation website page including a product promotion tool according to one example implementation of the system of FIG. 1.

FIG. 16 shows the digital marketing automation website page including a scheduled service promotion tool according to one example implementation of the system of FIG. 1.

FIGS. 17A-C show a customer device displaying deployed promotions resulting from use of the product promotion tool of FIG. 15 and the scheduled service promotion tool of FIG. 16.

FIG. 18 is a flowchart of a method for use with a computing device of the digital marketing automation system of FIG. 1.

FIG. 19 is an example computing system according to an implementation of the present description.

### DETAILED DESCRIPTION

Successfully drawing customers while spending a minimal amount of time and money on marketing is a goal of many businesses. Business as diverse as restaurants, retail stores, automotive services, day cares, etc., have a need to attract customers to purchase their products and services. Restaurant owners, as one example, may prefer to focus time and resources on producing product, the in-house responsibilities of an eating establishment, and the creative pursuits of food service. Thus, food service providers may opt to allow outside marketing companies to develop and distribute promotional materials. However, especially for small business owners, the cost of outsourcing to a marketing firm may not be reasonable. Also, some business owners may prefer to maintain greater control of their marketing. Given these business dilemmas, marketing activities that may be digitally packaged and automated to a degree as preferred by a business owner may be advantageous for restaurants and various other types of businesses as well.

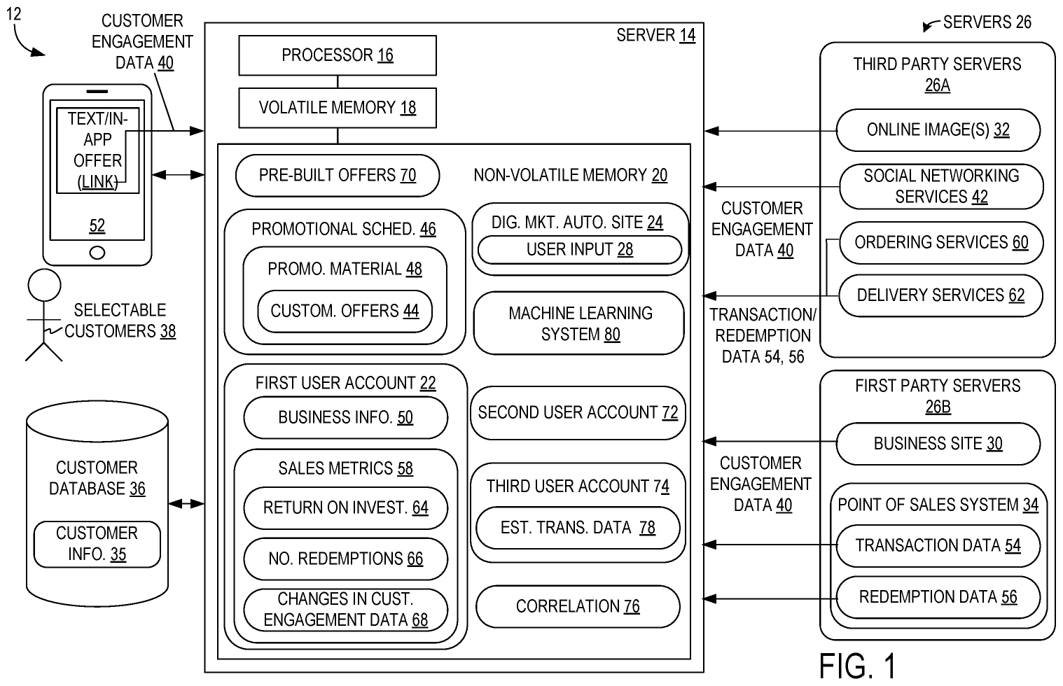

Systems and methods for digital marketing automation are described herein. FIG. 1 shows a digital marketing automation system 12 according to an example implementation of the present disclosure. The system 12 may include a server 14 that may include a processor 16 and associated storage. Volatile memory 18 and non-volatile memory 20 may be included in the associated storage. The processor may be a CPU, GPU, FPGA, ASIC, or other type of processor or integrated circuit. The processor 16 may be configured to execute instructions stored in the associated storage, specifically in the non-volatile memory 20.

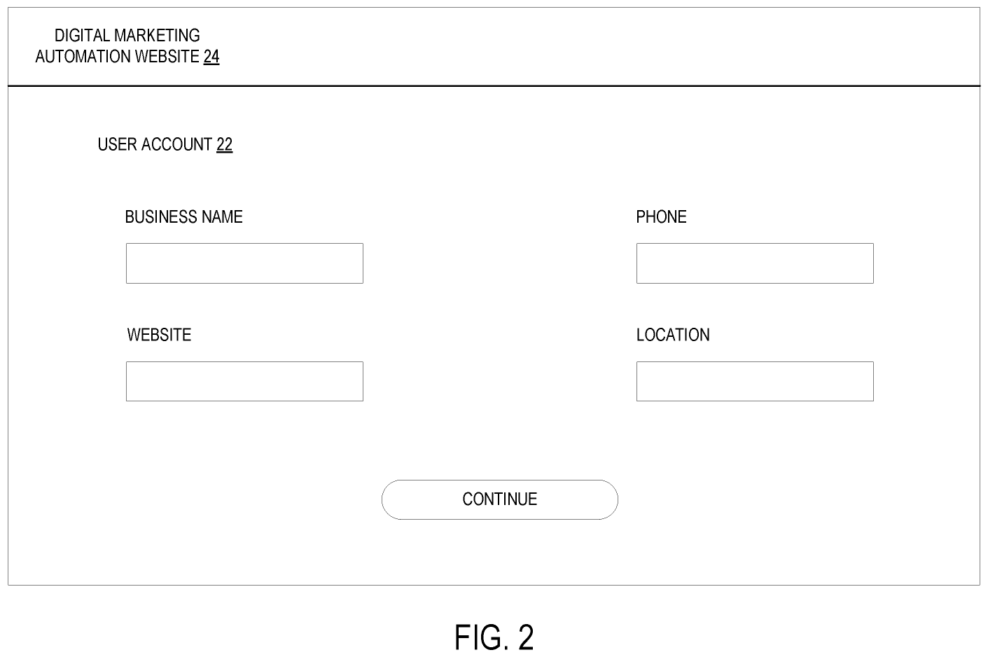

The digital marketing automation system 12 may operate in one or more phases. In a data collection phase, the processor 16 may be configured to execute the instructions to, after receiving an initializing command from a user, create a first user account 22, the first user account 22 shown as stored in the non-volatile memory 20 in FIG. 1. User accounts may be created via a digital marketing automation website 24 that may be executed on server 14 as shown, or at one or more servers 26 that may communicate with the server 14. A user may enter an initializing command as user input 28 to the digital marketing automation website 24, as shown schematically in FIG. 1. FIG. 2 shows an example page of an example implementation of a digital marketing automation website 24 that may be included in the digital marketing automation system 12. As shown in FIG. 2, a user may create a first user account 22. Depending on the configuration of the website 24, a user may enter personal information and/or information about the user's business, as shown in FIG. 2.

Returning to FIG. 1, the processor 16 may be configured to receive, for a business of the user, business information 50 from available websites and online images 32. Once the user enters a business name, for example, at the digital marketing automation website 24, an automatic search of online resources may be executed to extract information about the business of the user. Such information may be obtained, for example, from a publicly accessible business website 30 or server application programming interfaces (APIs) that may be accessible from the first party servers 26B. As used herein, first party servers 26B refers to servers under the control of the business, such as a web server or application server executing point of sales system 34. Other sources of information may include online images 32 related to the business of the user, which may be obtained from the business site 30 or from a third party server 26A. For example, the online images may be identified by performing an image search for the business name of the user, or performing a place search in a map database for the business of the user and identifying associated images that have been uploaded for the business as a place in the map database. In FIG. 1, the business website 30 is schematically shown as included at the one or more web servers 26, as are the online images 32. The business information 50 may be stored in the first user account 22 at the server 14 as shown in FIG. 1.

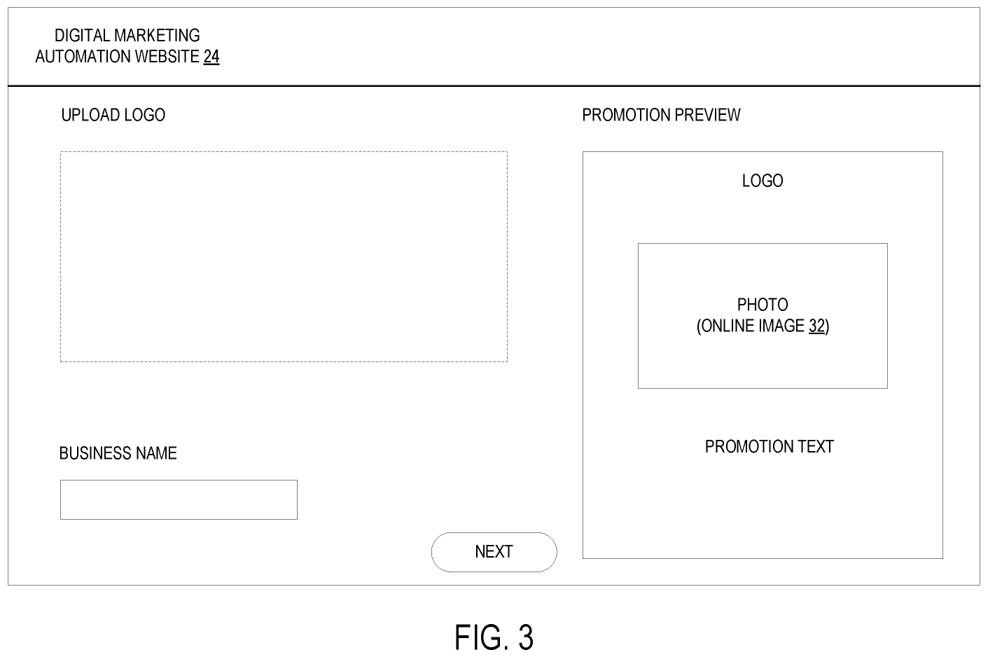

FIG. 3 shows another example of a page of the digital marketing automation website 24. At this page, a user may begin to customize business information that may be used to create a customized promotion for the business. The system 12 may incorporate business information 50 extracted from online resources; for example, an online image 32 from an automatic search of the system 12 based on the business information 50 entered by the user may be included in a suggested promotion displayed to the user on the page shown in FIG. 3. As another example, a business logo of the user may be included in the suggested promotion, the business logo extracted by the system 12 from the business website 30 of the user. Alternatively, the user may upload information such as the logo at the digital automation website 24.

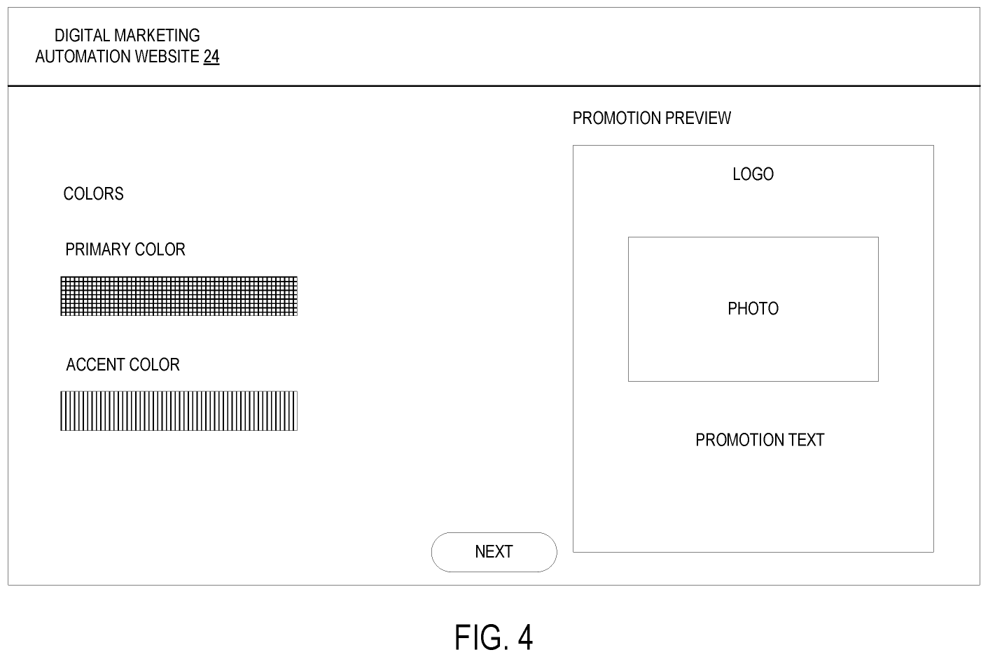

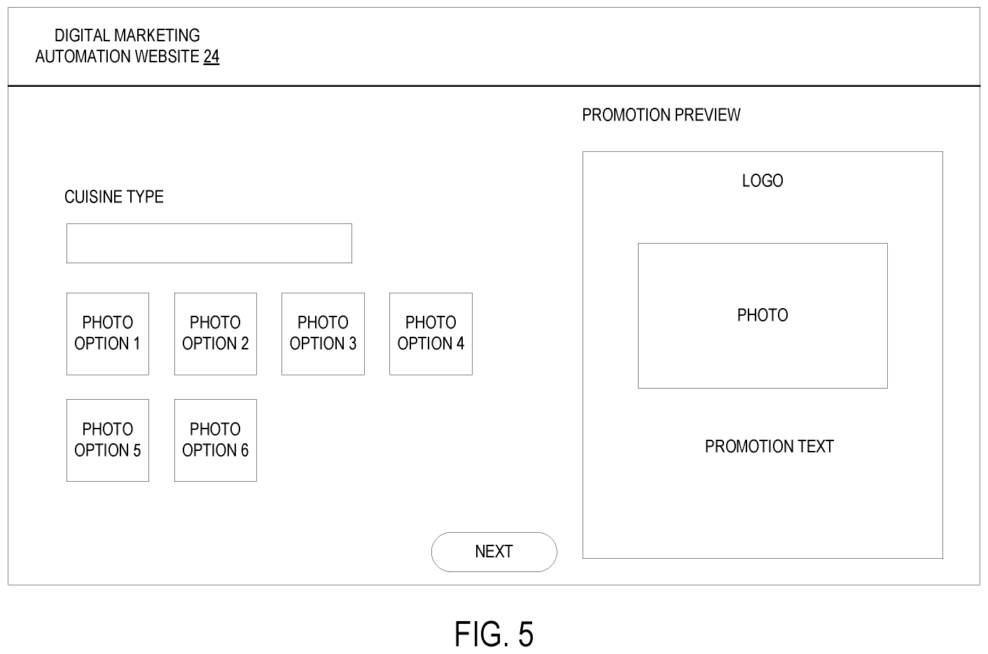

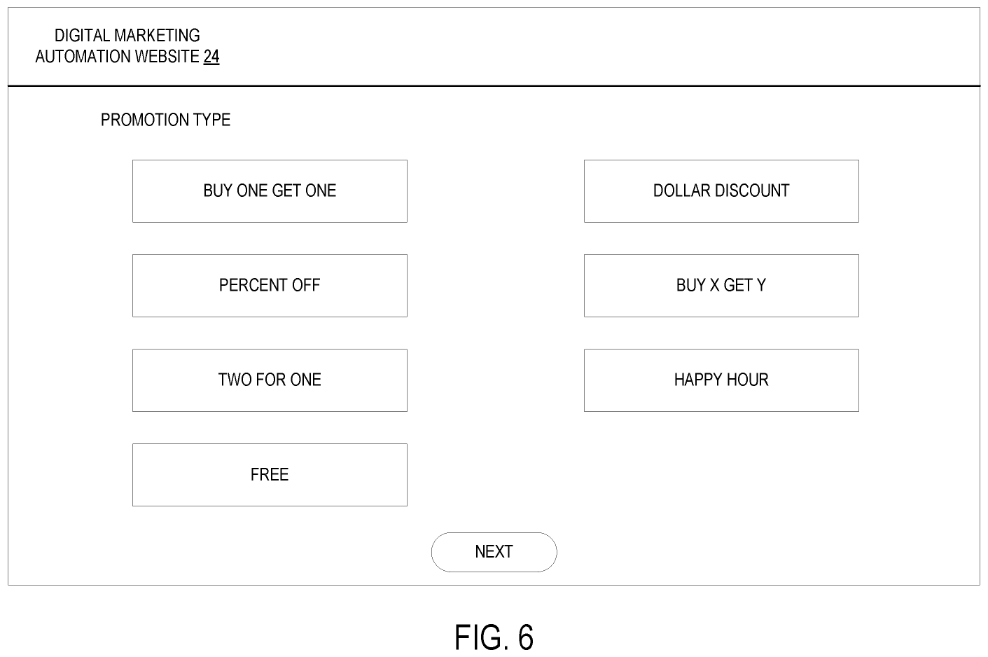

FIG. 4 shows another example page of the digital marketing automation website 24, the page of this example implementation for promotion customization by the user. Once the system 12 imports business information 50 from online resources and displays a suggested promotion to the user for the user's business, the user may be presented with various options by which to customize the suggested promotion. In the example of FIG. 4, the user may choose custom colors for the creation of a promotion, a preview of which may be displayed to the user. The colors used in the preview may be set by the digital marketing automation system 12 as a result of scanning a logo or other material from the business information 50. For example, the system could create a color histogram for a logo image file, and programmatically select a default color palate that matches dominant colors in the histogram. FIG. 5 depicts an example page of the digital marketing automation website 24 that may be presented for promotion creation. In this example, the user may specify a cuisine type for the user's business; sample photos may be presented to the user based on the selected cuisine type. From the user's selections and photo preferences, the suggested promotion may be further customized by the user to include cuisine-related content and images. FIG. 6 shows another example page of the digital marketing automation website 24 that may be presented for promotion creation. A potential advantage of the digital marketing automation system 12 is that the user may decide the types of promotions that are sent to selectable customers 38, although the creation and dissemination of the promotions may be largely automatic. In FIG. 6, the user may select from a variety of promotion types, including buy-one-get-one, percent off an item, two-for-one items, free items, a dollar amount discount, a purchasing bonus of the form “buy X receive Y”, and/or a happy hour promotion. It will be appreciated that the promotions shown in FIG. 6 represent a sample of promotions that may be generated by the digital marketing automation system 12.

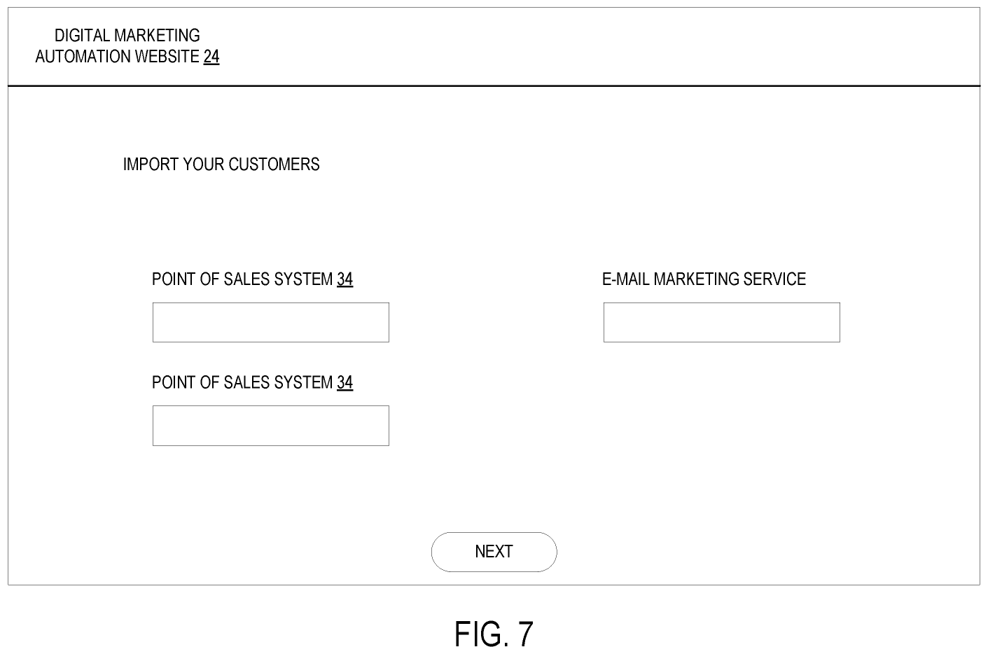

The processor 16 may be configured to, further in the data collection phase, receive customer information 35 from one or more point of sales systems 34 of the user, and from the customer information 35, generate a customer database 36 of selectable customers 38. FIG. 7 shows an example website page for the digital marketing automation website 24 for importing customers. In this configuration, a user may have one or more point of sales systems 34 by which business transactions with customers transpire. In the first user account 22 as shown in FIG. 7, the user may enter the one or more point of sales systems 34 of the user's business that may include the customer information 35. Additionally, the digital marketing automation website 24 may include other options for inputting customer information 35, such as in a case where a user employs an e-mail marketing service. As with the point of sales systems 34, the user may enter an e-mail marketing service account into an appropriate field as shown in FIG. 7, either alone or in conjunction with the one or more point of sales systems 34. Once entered into the appropriate fields on the digital automation website 24, customer information 35 may be extracted by the system 12 from the one or more point of sales systems 34 and any other customer information 35 sources such as an e-mail marketing service. This customer information 35 may be stored in a customer database 36 that may be generated by the system 12.

In the example configuration of FIG. 1, point of sales system 34 is shown as included in the one or more first party servers 26B. In other embodiments, the point of sales system 34 could be a cloud hosted service located at a third-party server 26A. The customer database 36 may be generated and in communication with the server 14. It will be appreciated that not all customers included in the one or more point of sales systems 34 and/or other customer information sources may be receptive to marketing and promotions. As such, in one example configuration, only customers previously designated as having opted-in for promotions in the customer information sources such as the one or more point of sales systems 34 may be imported to the customer database 36. Thus, the selectable customers 38 may include those who have opted-in to receiving promotions and/or other marketing offers. It will be appreciated that other methods may be employed to determine the selectable customers 38, such as filters and/or opt-out messages.

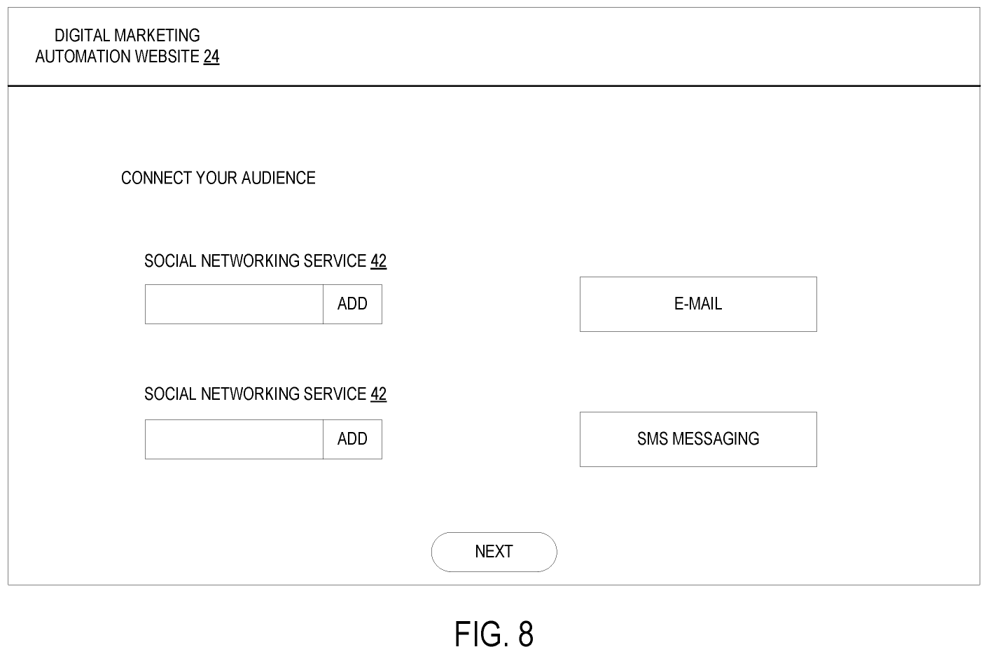

The processor 16 may be configured to, in a connection phase, receive input designating services utilized by the user for customer interactions. FIG. 8 displays another example page of the digital marketing automation website 24 for connecting customers. In this configuration, one or more social networking services 42 that the user employs for business information and customer interaction may be entered into the appropriate fields of the webpage. The designated services utilized by the user for customer interactions may include at least one of social networking services 42, ordering services 60, and delivery services 62, each of which are shown in FIG. 1 as being accessible from the one or more third party web servers 26A. The system 12 may then, via the processor 16, connect data input from the one or more point of sales systems 34 and from the designated services utilized by the user for customer interactions, such as one or more social networking services 42, as customer engagement data 40 shown in FIG. 1 as communicable from the one or more servers 26 to the server 14. The customer engagement data 40 may be stored in the customer database 36. The customer engagement data 40 may include at least one of clicks on links in in-app or in-browser offers, clicks on texts, social media activity, and business-related website activity, as shown in FIG. 1. Thus, customer engagement data 40 may be extracted by the system 12 from the one or more point of sales systems 34, one or more social networking services 42 designated by the user at the website 24, the business website 30, communications sent to the selectable customers 38 such as texts and e-mails, and/or other digital communication and/or online activities. Once the designated services are entered by the user at the website 24, the user may be given options as to the means by which selectable customers 38 may be engaged. As shown in FIG. 8, e-mail and/or SMS messaging may be selected by the user to reach the selectable customers 38. Once these preferences and inputs have been set at the website 24, the processor 16 may be configured to receive continuous customer engagement data 40 from the connected data input to the customer database 36. In FIG. 1, customer engagement data 40 is depicted schematically as communicated from the one or more servers 26 to the server 14 by the system 12, and from the customer device 52 to the server 14. The customer engagement data 40 may then be imported to the customer database 36.

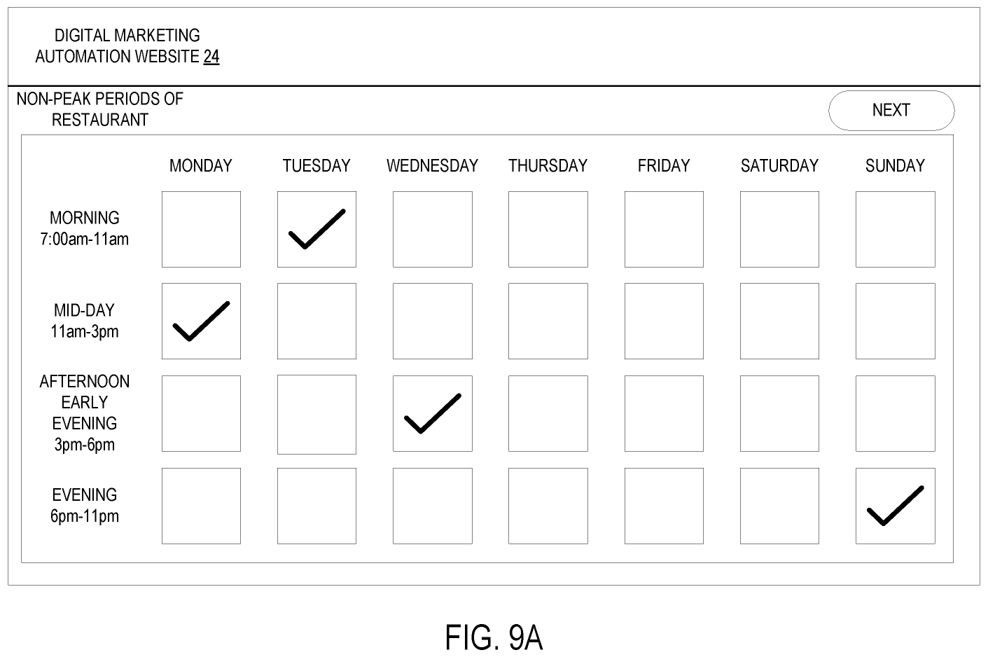

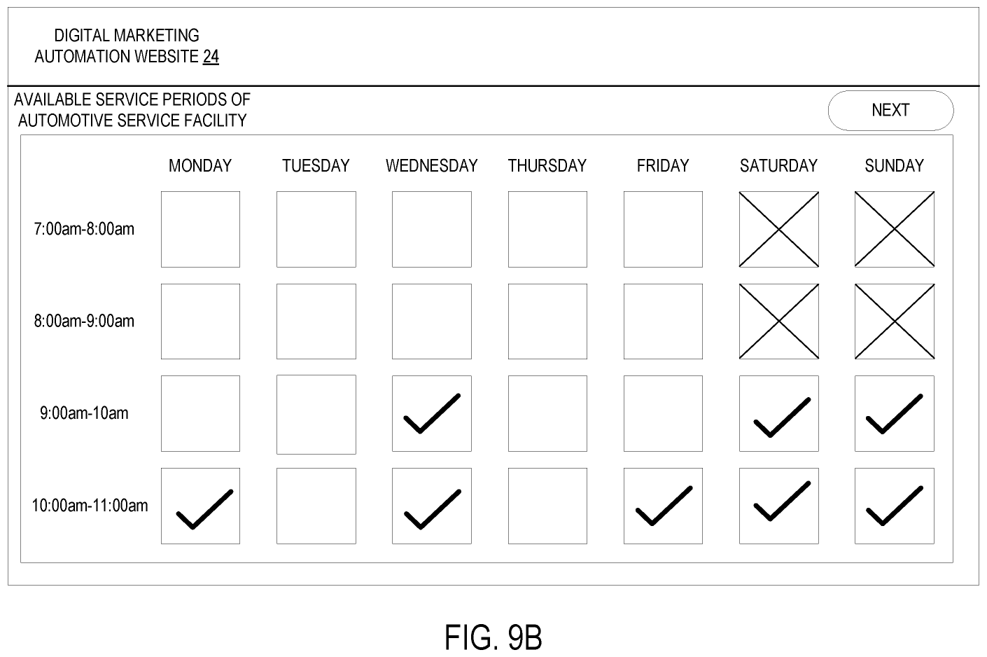

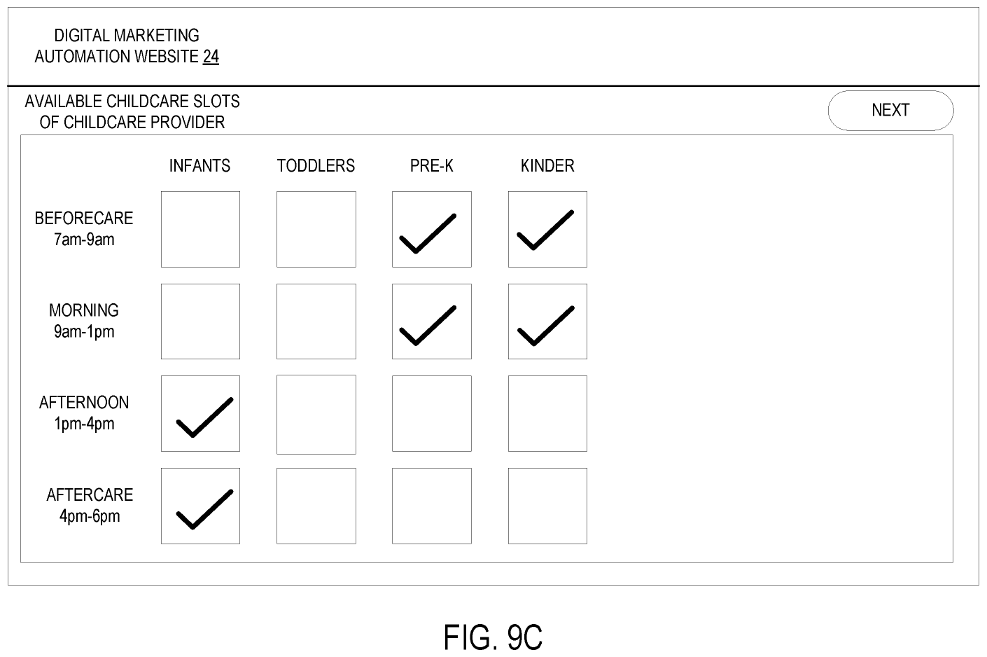

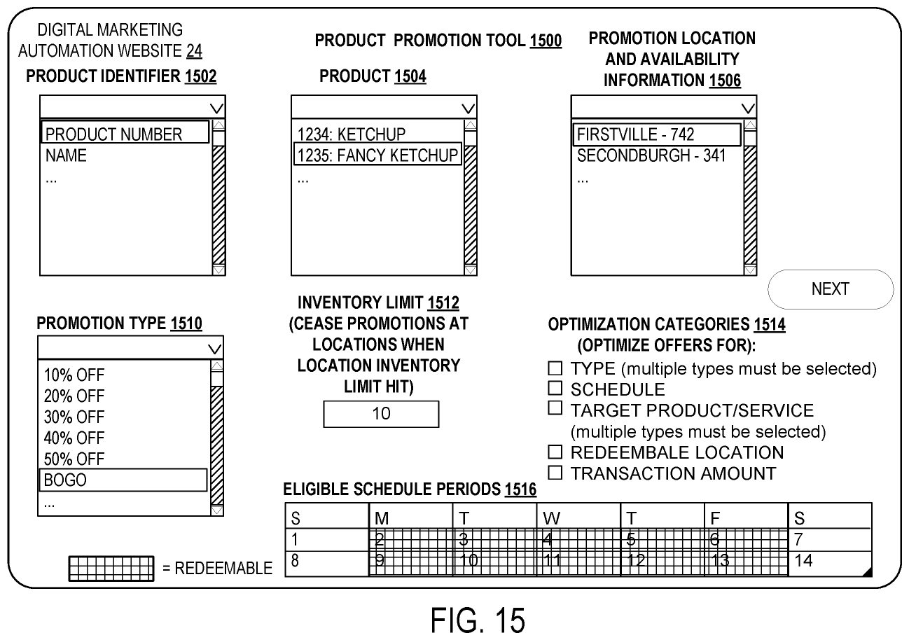

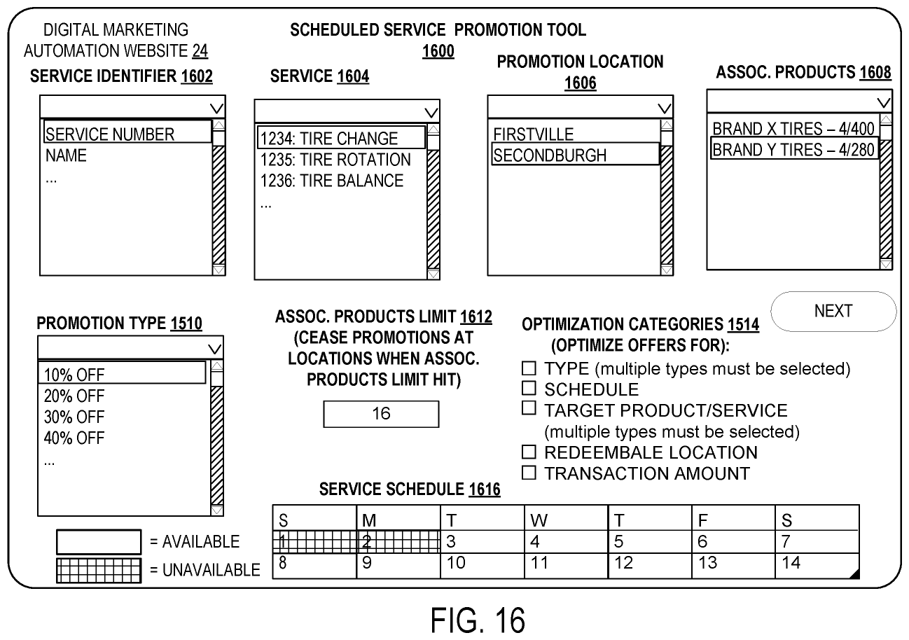

The processor 16 may be configured to, in a building phase, receive input specifying at least one available product or service. FIGS. 9A-9C illustrate three different examples of user interfaces configured to receive inputs indicating available services, as does FIG. 16 described below, while FIG. 15 described below illustrates an example user interface configured to receive user inputs indicating available products. Turning now to FIG. 9A one specific example of a page of the digital marketing automation website 24 for designation of non-peak business time periods for the business of the user is illustrated. As shown, a user may choose, for each day of the week, morning, mid-day, afternoon/early evening, and evening periods, which it will be appreciated may correspond to breakfast, lunch, happy hour, and dinner service periods at a restaurant. A user may select those periods that a business location is slow, and during which promotions should be redeemable. FIG. 9B illustrates a similar web page for an available service periods of an example automotive service facility. The user may programmatically or manually provide inputs indicating available service period slots at a given business location. FIG. 9C is an illustrate of a web page by which a user may indicate available childcare slots of an example childcare provider. The user may indicate, for each of plurality of age group classes of the childcare facility, for each of a plurality of periods of the day, which classes have open slots. Although not illustrated, this interface may be provided with day of week granularity if desired, to accommodate mon-wed-fri and tue-thur schedules, for example.

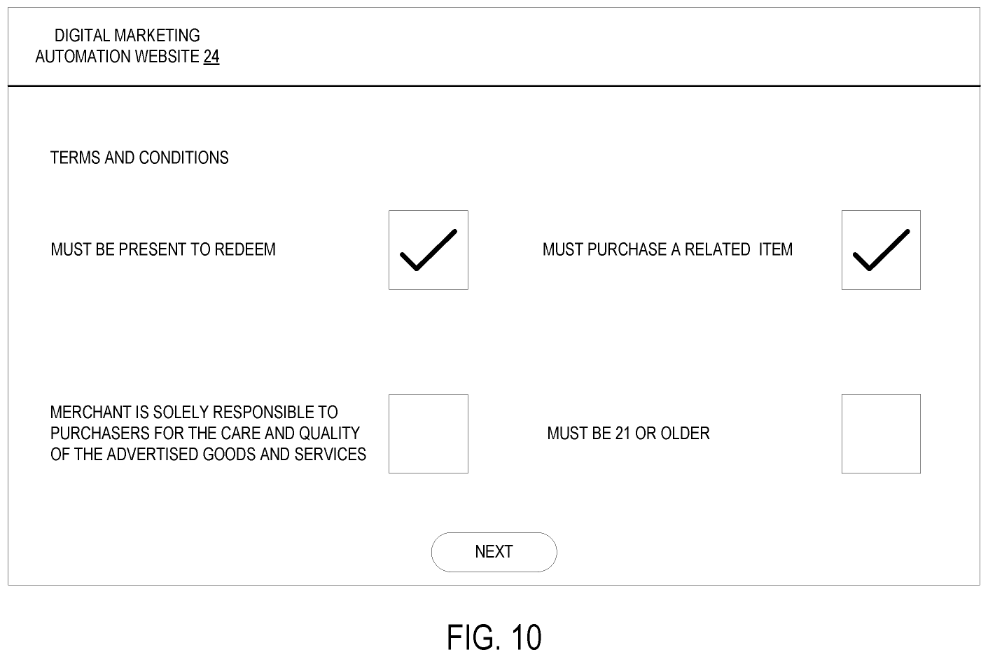

It will be appreciated that terms and conditions may also be set by the user. FIG. 10 shows an example page of the digital marketing website 24 for setting terms and conditions. In this example, the user may specify that in order for a customer to redeem a promotion, the customer may need to be present, must purchase a related item (e.g., a food item for a restaurant, an oil change for an automotive service facility, sibling care at a childcare facility, etc.), and/or must be 21 or older in the case of legally restricted sales. A separate interface may be provided to designate the related item. In FIG. 10, the user has selected “must be present to redeem” and “must purchase a related item”. Other terms and conditions may be included that are not shown in FIG. 10 that may be selected by the user.

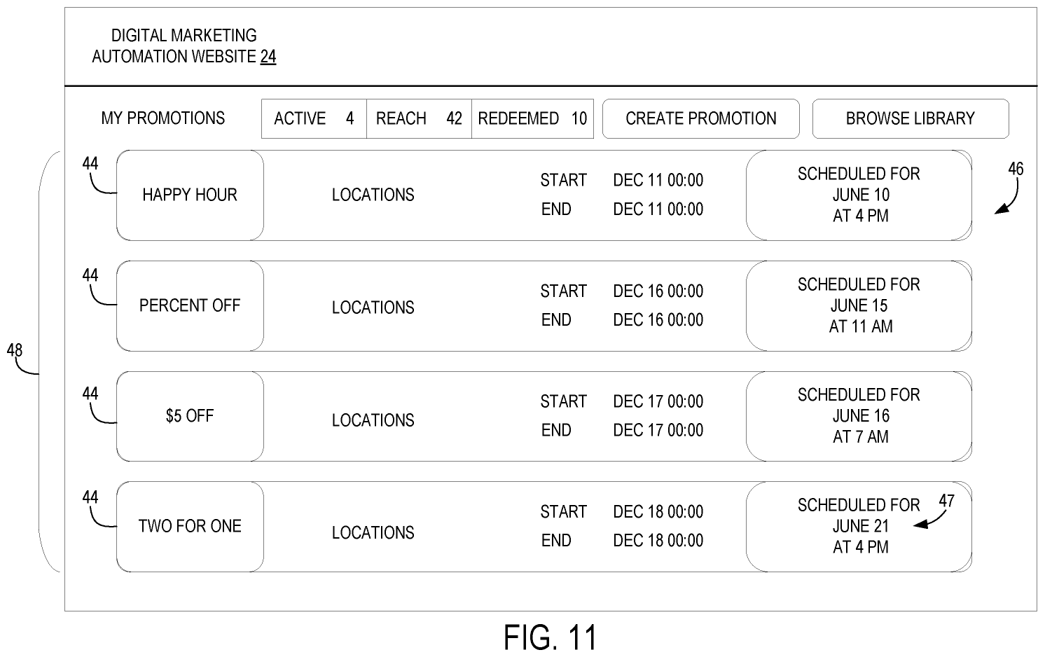

Once the user inputs days and times when products and services are available and customer transactions are desired to be increased, and in some configurations also inputs terms and conditions, the processor 16 may be configured to generate customized offers 44 to be sent to the selectable customers 38 based at least on the business information 50, examples of which are shown in FIG. 11, for the specific example of restaurant promotions. The processor 16 may be further configured to, based on the at least one available product or service, generate a promotional schedule 46 for a predetermined period of time 47 for promotional material 48 including the customized offers 44 to be sent to the selectable customers 38. The schedule may be generated based on the available period, i.e., the non-peak business time of FIG. 9A, available schedule periods of FIG. 9B, available class slot of FIG. 9C, as some examples. The example page of the digital marketing automation website 24 shown in FIG. 11 includes several possible customized offers 44 that may be generated organized according to a sample promotional schedule 46. In the example of FIG. 11, the customized offers 44 have been scheduled for the non-peak business time periods previously indicated by the user via the interface of FIG. 9A. Additionally, the promotional schedule 46 may be set for a predetermined period of time 47, an example of which may be a three-month schedule of promotional material 48. In FIG. 11, the predetermined period of time 47 is shown at the last customized offer 44, after which no further offers may be generated. It will be appreciated that the predetermined period of time 47 may be set by the system 12 or may be set by the user. It will be appreciated that the interface of FIG. 11 may be customized for use with the automotive service facility and childcare facility examples described above, or for use with business offering other types of products and services.

As suggested above, the processor 16 may be further configured to receive user input 28 to customize at least one of the promotional schedule 46, the predetermined period of time 47, the promotional material 48, and the customized offers 44. With respect to the customized offers 44, in some configurations the user may select, from a collection of pre-built offers 70 included in the system 12 (shown in FIG. 1), preferred pre-built offers, and the generation of customized offers may be based at least on the business information 50 and the user selection of preferred pre-built offers. Returning to FIG. 11, also depicted is an option to create a promotion or browse a library of promotions, which may give a user greater control in customization of the promotional material 48. While the customized offers 44 are examples of promotional material 48, other types of promotional material 48 may be generated, such as announcements, invitations to special events, and so forth. The digital marketing automation website 24 may also include information for the user pertaining to the promotional material 48. For example, in FIG. 11, it is displayed that four customized offers 44 are currently active, forty-two selectable customers 38 are currently reached, and ten customized offers 44 have been redeemed.

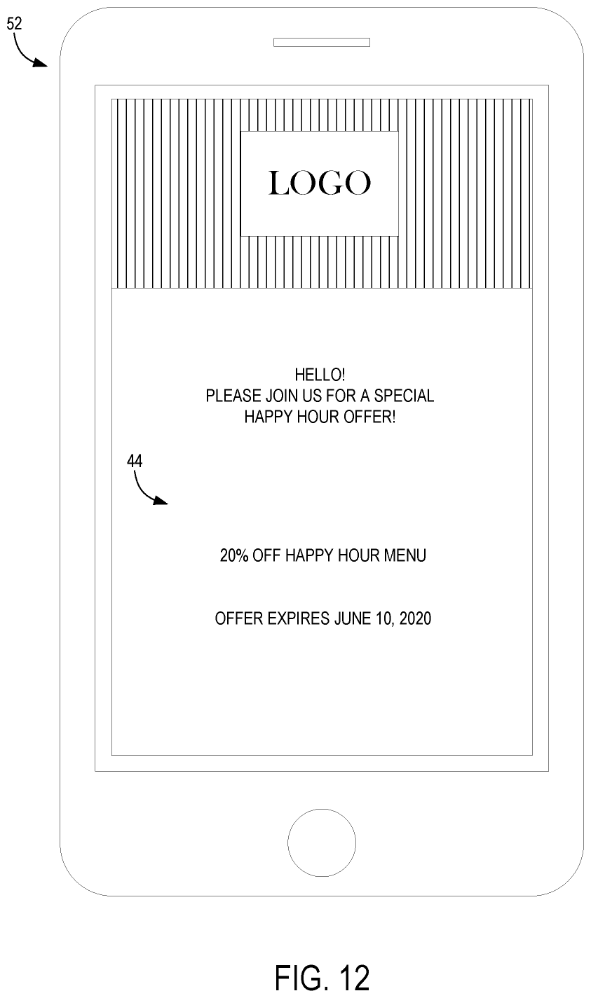

FIG. 12 shows an example of a customer device 52 displaying a deployed promotion that is a customized offer 44. The customer device 52 may be, for example, a smartphone, a tablet, a personal computer, a head-mounted display device, and so forth. In the example of FIG. 12, the generated promotion includes a logo of the business of the user that may have been stored as business information 50 and a customized appearance as selected by the user and described above. The promotional message and text may be autogenerated by the system 12 or may have been customized by the user. Included in the customized offer 44 is a percent-off discount and an expiration based on the promotional schedule 46, which may also be customized by the user. The customized offer 44 may have been deployed according to the promotional schedule 46 shown in FIG. 11 to selectable customers 38.

The processor 16 may be further configured to, in an analysis phase, from the one or more point of sales systems 34, receive transaction data 54 and promotional material redemption data 56. FIG. 1 shows the transaction data 54 and promotional material redemption data 56 as included in the point of sales system 34; this data may be imported to the server 14. Once received, the processor 16 may be configured to compile data including the transaction data 54, the promotional material redemption data 56, and the customer engagement data 40, all of which may be stored on the server 14 and/or the customer database 36. From the compiled data, the processor 16 may be configured to output one or more sales metrics 58 representing customer response to the promotional material 48. In FIG. 1, the sales metrics 58 are shown as included in the first user account 22. The one or more sales metrics 58 representing customer response to the promotional material 48 may include at least one of return on investment 64, total number of promotional material redemptions 66, metrics representing changes in customer engagement data 68 based on the connected data input, comparisons between pre-release and post-release of the promotional material, and average number of sales. In FIG. 1, the example implementation of the system 12 includes return on investment (ROI) 64, total number of promotional material redemptions 66, and metrics representing changes in customer engagement data 68. These and other sales metrics 58 may be displayed on the digital marketing automation website 24 as described below.

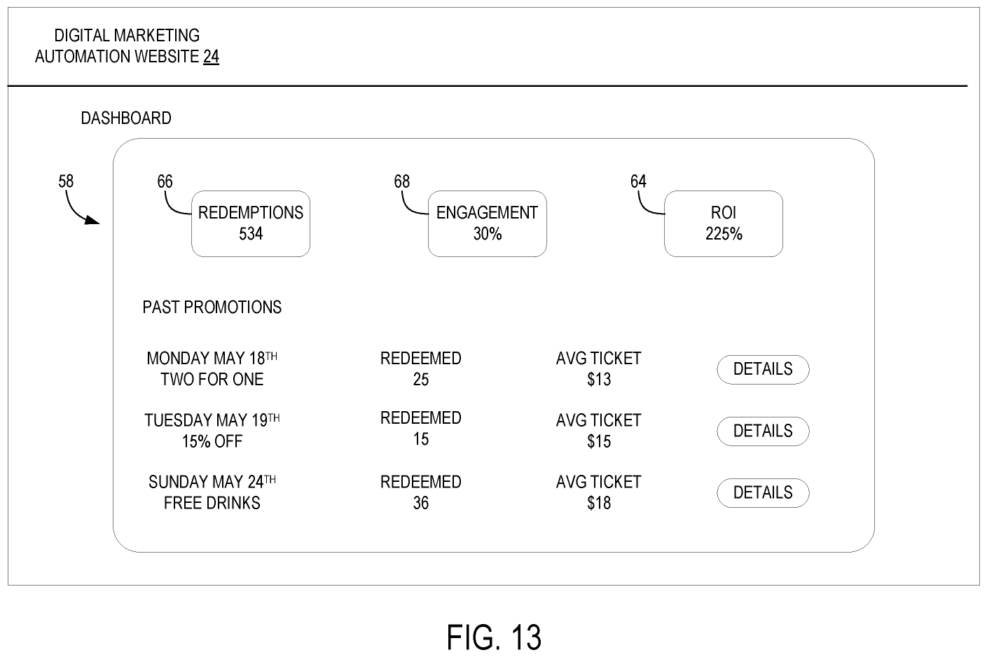

FIG. 13 shows an example of a dashboard page of the digital marketing automation website 24. In this example, past promotions are shown for the user. For each past promotion, the promotion, date of the promotion, number of redeemed promotions, and average ticket price for the promotional period (e.g., a happy hour period) are shown, as well as an option for further details on the past promotion. Also shown on the example dashboard page is the total number of promotional material redemptions 66, a percentage factor for changes in customer engagement data 68, and return on investment 64, these values being included as the sales metrics 58. It will be appreciated that various values, statistics, totals, and so on may be included in the sales metrics 58. Preferred sales metrics and reporting may be customized by the user in the system 12.

In the examples discussed above, the user may have at least one point of sales system 34 from which customer information 35 and transaction data 54 may be drawn into the customer database 36 for generation of the promotional schedule 46. However, a potential advantage of the configuration is that a user need not have a point of sales system 34 in order to generate the promotional schedule 46. In this implementation, the system 12 may include a plurality of user accounts. FIG. 1 shows second user account 72 and third user account 74 on the server 14 as examples of additional user accounts. The processor 16 may be further configured to, in the analysis phase, for a plurality of user accounts that include the one or more point of sales systems 34 and from the customer engagement data 40, determine a correlation 76 between the transaction data 54 and the customer engagement data 40, such as engagement data from with a social network service 42. The correlation 76 may be stored on the server 14 as shown in FIG. 1. For the user accounts that do have one or more point of sales systems 34, the correlation 76 between the transaction data 54 and the customer engagement data 40 represents customer activity as an indicator of actual transactions for a given period of time. As such, for at least one user account that does not include the one or more point of sales systems 34, based on the correlation 76 and customer engagement data 40 for the at least one user account that does not include the one or more point of sales systems 34, estimated transaction data 78 may be determined.

In FIG. 1, the third user account 72 may not have one or more point of sales systems 34. Instead, the correlation 76 may be utilized to determine estimated transaction data 78 for third user account 72. Once determined, the estimated transaction data may be utilized for the at least one account that does not include the one or more point of sales systems 34 similarly as the actual transaction data 54 is processed in the user accounts that do have the one or more point of sales systems 34. That is, when the sales metrics 58 may be output based on the customer engagement data 40 rather than the transaction data 54. For customer information 35 that may otherwise be drawn from the one or more point of sales system 34, it will be appreciated that the customer information 35 may be added by the user manually or may be drawn from another source, database, etc.

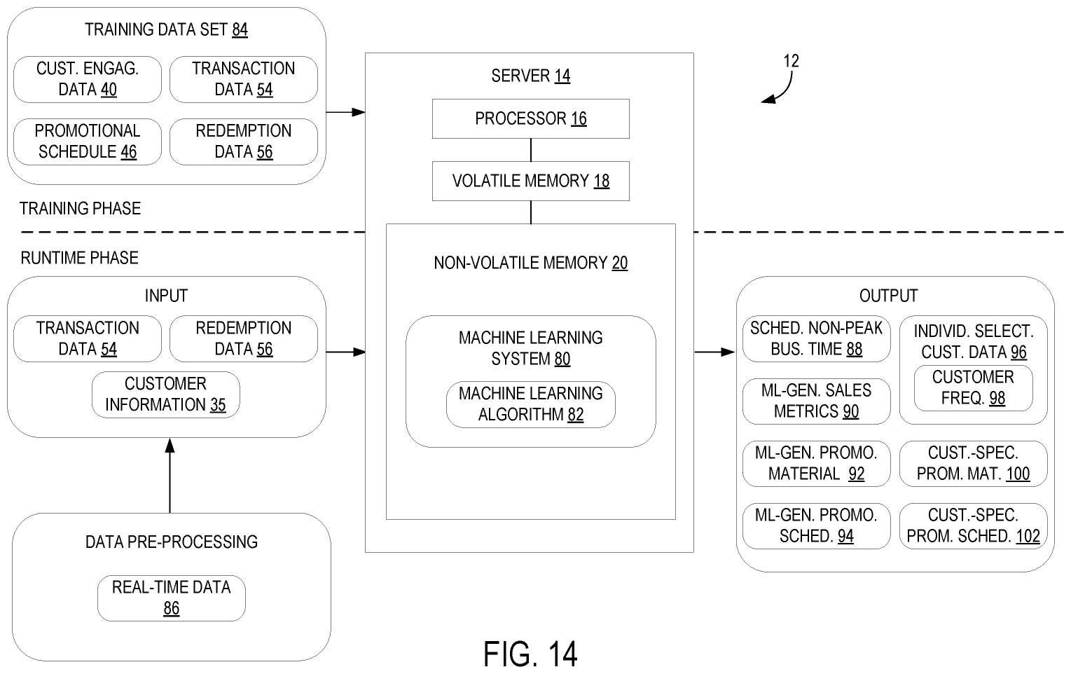

The discussion above includes example implementations of the digital marketing automation system 12. It will be appreciated that these example implementations may be executed as described. However, further example implementations may utilize machine learning (ML) to achieve some of the outputs described above as well as additional outputs of the system 12. FIG. 14 shows an example implementation of the server 14 of FIG. 1. It will be appreciated that any of the components included in FIG. 1 may be included with the server 14 in FIG. 14, however for the sake of simplicity only selected components such as the processor 16, the volatile memory 18, and the non-volatile memory 20 are shown. Also included with the server 14 may be a machine learning (ML) system 80. When a machine learning system 80 is included, a machine learning (ML) algorithm 82 may be trained with a training data set 84 in a training phase. Input data may be pre-processed to convert the data, for example, into input vectors that may be received by the machine learning algorithm 82. It will be appreciated that other pre-processing steps may be included. It will be further appreciated that various types of ML algorithms and/or neural networks may be included in the ML system 80.

In this implementation, the processor 16 may be configured to, in a training phase, input to an ML algorithm 82 at the ML system 80 a training data set 84 including at least the customer engagement data 40, the promotional schedule 46, the transaction data 54, and the promotional material redemption data 56. In this configuration, from the training data set 84, the ML algorithm 82 may be trained to identify the one or more sales metrics 58 representing customer response to the promotional material 48 that may, for example, include the customized offers 44. Examples of the training data set 84 input to the machine learning system 80 are shown in FIG. 14.

Once the ML algorithm 82 is trained, the processor 16 may be configured to, in a runtime phase, input to the trained ML algorithm 82 real-time data 86 from the one or more point of sales systems 34 including the transaction data 54 and the promotional material redemption data 56. The real-time data 86 from the one or more point of sales systems 34 may be input from the one or more web servers 36 in communication with the server 14 as shown in FIG. 1. As briefly discussed above, data may be prepared at a data pre-processing step to convert the data into a form acceptable to the machine learning algorithm 82, such as a set of input vectors. The processor 16 may be configured to output, via the trained ML algorithm 82, a schedule of actual non-peak business time periods 88 and one or more ML-generated sales metrics 90 representing customer response to the promotional material 48, as shown in FIG. 14. In this implementation, the ML algorithm 82 may be a classifier for ML-generated sales metrics 90 given the training data set 84. The schedule of actual non-peak business time periods 88 may replace the user input specifying non-peak business time periods shown in the example implementation of FIGS. 9A-9C, as it may be based on actual transaction data 54 of the business of the user. Therefore, future promotional schedules generated by the system 12 may incorporate the actual non-peak business time periods 88. The processor 16 may be further configured to generate, via the trained ML algorithm 82, ML-generated promotional material 92 and an ML-generated promotional schedule 94 for the ML-generated promotional material 92 to be distributed to the selectable customers 38. By incorporating an ML system 80 in this manner, the ML algorithm 82 may be trained to create ML-generated promotional material 92 that may be both customized to a given user and optimized for a business in the food industry that may experience regular fluctuations. By processing the real-time data 86, the output ML-generated promotional schedule 94 may be updated on an ongoing basis for the business of the user.

The processor 16 may be further configured to, in the runtime phase, input to the trained ML algorithm 82 the customer information 35 of the selectable customers 38, the transaction data 54, and the promotional material redemption data 56 as shown in FIG. 14. The customer information 35 may be sourced from the customer database 36 or input in real-time from the one or more point of sales systems 34 or other online sources at the one or more web servers 26 as shown in FIG. 1. Following this input, the processor 16 may be configured to determine, via the trained ML algorithm 82, individualized selectable customer data 96 including at least customer frequency 98 as shown in FIG. 14. Since the customer information 35 is input to the ML system 80 along with the other inputs, transaction data 54 and possibly customer engagement data 40 may be processed for individual customers. For example, customer frequency 98 at the business of the user may be determined. With this information, the processor 16 may be configured to, via the ML algorithm 82, generate customer-specific promotional material 100 to be distributed on a customer-specific promotional schedule 102. While the customized offers 44 described above may allow a user to distribute promotional material 48 broadly to a customer base, the capacity to target and potentially reward specific customers with customer-specific promotional material 100 on a timetable that is also customer specific may be a more sophisticated and advantageous marketing approach.

Although in the above examples, the digital marketing automation system 12 is described in the context of promoting a business with at least one location, the digital marketing automation system 12 may also be used to promote businesses with more than one location or businesses in which at least one available product or service is offered at a plurality of locations. Examples of such businesses include franchise-based operation or companies with multiple corporate owned stores (e.g., 10s, 100s, or 1000s of stores), however the digital marketing automation system 12 may also be used to promote a business with a smaller number of stores such as two or three stores, for example. The available product or service may be selected from the group consisting of a service that is scheduled, a service featuring an organized activity having participation slots, a product that is stored in inventory, and a product that is prepared on site. For such businesses, the digital marketing automation system 12 provides features to enable the business owner to target promotions to particular locations. For example, the digital marketing automation system 12 is configured to receive input specifying at least one target location of the plurality of locations where the customized offers are eligible for redemption. This feature may be used by a business wishing to promote an underperforming store, for example. Additionally, the digital marketing automation system 12 is configured to vary the promotion type, promotional schedule, target product or service, and/or redeemable location of the customized offer based upon feedback collected from engagement, redemption, and transaction data for previously presented offers.

As discussed above, customer engagement data 40 may include at least one of clicks on links, clicks on texts, social media activity, and business-related website activity. Redemption data 56 may include total number of promotional material redemptions, as well as timing of individual promotional material redemptions. Transaction data includes data collected from point of sales systems used by the business. These and other data may be used by the ML algorithm 82 vary the promotion type, promotional schedule, target product or service, and/or redeemable location of the customized offer, through A/B testing in the training phase, for example. These additional features may be further appreciated through the following examples.

FIG. 15 shows an example page of an example implementation of the digital marketing automation website 24 for a producer of a retail product, namely a ketchup producer, ketchup being a product that is stored in inventory and offered for sale through wholesale and resale channels. In this example page, is a product promotion tool 1500 having fields including a product identifier field 1502, a product field 1504, a promotion location and product availability field 1506, a promotion type field 1510, an inventory limit field 1512, an optimization categories field 1514, and an eligible schedule periods field 1516. Each field is populated with one or more field options. It will be appreciated that these fields are exemplary, and that the product promotion tool may include additional fields or omit one or more of the fields depicted in this example. In this example, product number is selected from the product identifier field 1502, which in turn causes the product field 1504 to be populated with products in order of product number. The promotion location and product availability field 1506 is populated with locations having in inventory, the product selected in the product field as well as the number of the product in inventory. In this example, Firstville has 742 fancy ketchups in inventory, and Secondburgh has 341 fancy ketchups in inventory. The digital marketing automation system 12, is able to correctly populate the fields in the page of the digital marketing automation website 24 through coordination with an inventory management system, wherein an availability of the available product or service at the at least one target location is indicated by an inventory management system. BOGO (buy one get one free) is selected from the promotion type field 1510. From the inventory limit field 1512, 10 is selected which results in the digital marketing automation system 12 to cease sending the customized offers when ten fancy ketchups are available. This is accomplished by the inventory management system indicating that the availability of the product or service drops below a predetermined threshold, at which point the processor is configured to cease sending the customized offers. As mentioned above, ketchup is a product that is stored in inventory, however, the inventory management system may also be configured to operated with a product that is made on site. For a product that is made on site, the inventory management system indicates when the availability of a component of the product that is made on site drops below a predetermined threshold, at which point the processor is configured to cease sending the customized offers. For example, an ice cream shop using the digital marketing automation system 12 may cease sending offers for banana splits when the availability of bananas drops below a predetermined threshold, as another specific example for the purposes of illustration.

Continuing with FIG. 15, the optimization categories field 1514 of the product promotion tool 1500 allows selection of an optimization category which causes the digital marketing automation system 12 to vary the promotion type, promotional schedule, target product or service, and/or redeemable location of the customized offer based upon feedback collected from engagement, redemption, and transaction data for previously presented offers depending on the selected optimization category. In this example, no optimization category is selected, however any of the optimization categories may be selected in other examples. The eligible schedule periods field 1516 indicates dates and times when the customized offer is redeemable and is used in generating the promotional schedule 46.

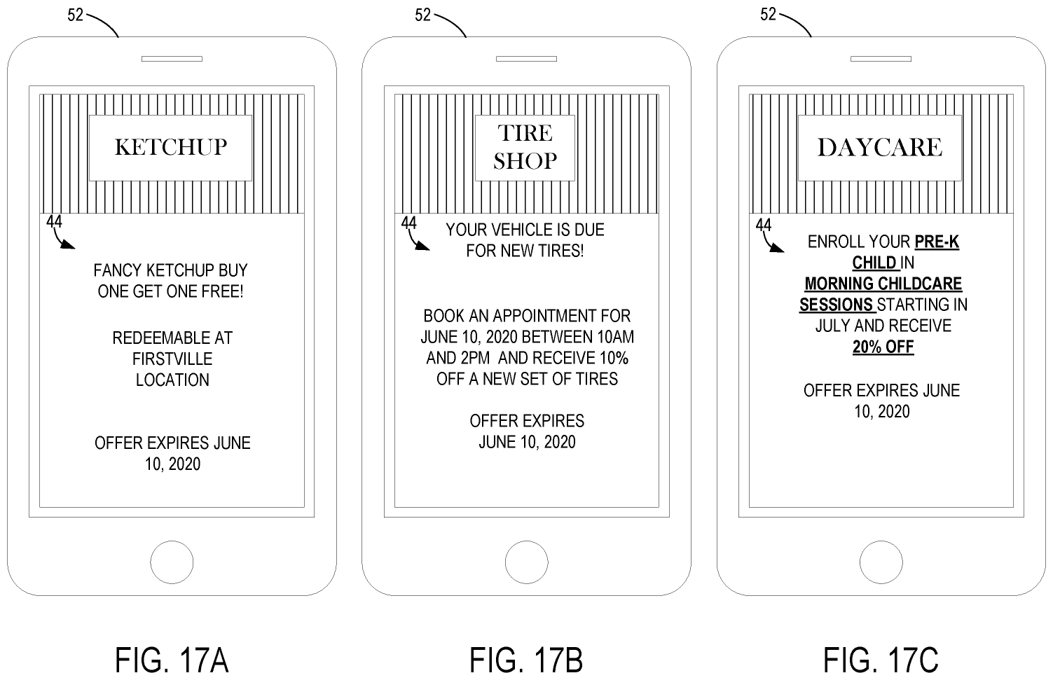

As a result of the above selected field options, the digital marketing automation system 12 generates a customized offer 44 for fancy ketchup. FIG. 17A shows an example of a customer device 52 displaying the customized offer 44. Included in the customized offer 44 is a BOGO discount for fancy ketchup redeemable only at the Firstville location with an expiration of Jun. 10, 2020 based on the promotional schedule 46, which may also be customized by the user. The customized offer 44 has been deployed according to the promotional schedule 46 to selectable customers 38.

Turning now to FIG. 16, an example page of an example implementation of the digital marketing automation website 24 for a service provider, namely an automotive service facility in the form of a tire shop is shown. The tire shop offers services that are scheduled such as a tire rotation or a tire change. For such services, the digital marketing automation system 12 may in part base the promotional schedule on time since a customer last purchased the service.

Continuing with FIG. 16, in this example page, is a scheduled service promotion tool 1600 having fields including a service identifier field 1602, a service field 1604, a promotion location field 1606, an associated products field 1608, the promotion type field 1510, an inventory limit field 1612, an optimization categories field 1514, and an eligible schedule periods field 1616. Each field is populated with one or more field options. It will be appreciated that these fields are exemplary, and that the scheduled service promotion tool 1600 may include additional fields or omit one or more of the fields depicted in this example. In this example, service number is selected from the service identifier field 1602, which in turn causes the service field 1604 to be populated with services in order of service number. The promotion location field 1606 is populated with locations offering the selected service. In this example, Secondburgh is selected. The associated products field 1608 is populated with field options, the field options being associated products that may be used in fulfilment of the selected service. In this example, a tire change requires new tires from inventory. The associated products field 1608 shows different options for the new tires, i.e., Brand X and Brand Y, as well as the number of associated products required for the selected service and the number of associated products remaining in inventory. In this example, four Brand Y tires are required for the selected service and 280 Brand Y tires are in inventory. While this example shows at least one associated products field 1608 for the selected service, it will be appreciated that other services may include more than one associated products field. An oil change, for example, may include motor oils in a first associated products field and oil filters in a second associated products field.

Continuing with FIG. 16, from the promotion type field 1510, “10% off” is selected. From the associated product limit field 1612, 16 is selected which results in the digital marketing automation system 12 to cease sending the customized offers when 16 Brand Y tires are available. This is accomplished by the inventory management system indicating that the availability of the product or service drops below a predetermined threshold, at which point the processor is configured to cease sending the customized offers. Continuing with FIG. 16, the optimization categories field 1514 of the scheduled service promotion tool 1600 allows selection of the optimization category which causes the digital marketing automation system 12 to vary the promotion type, promotional schedule, target product or service, and/or redeemable location of the customized offer based upon feedback collected from engagement, redemption, and transaction data for previously presented offers depending on the selected optimization category. In this example, no optimization category is selected, however any of the optimization categories may be selected in other examples. The service schedule field 1616 indicates dates and times when the business is available to provide the selected service. In this example, the first and second days of the month are booked and unavailable for further service. When generating an offer for a service, the digital marketing automation system 12 varies the promotion schedule based upon service availability shown in the service schedule. As a result of the above selected field options, the digital marketing automation system 12 generates a customized offer 44 for a tire change, which is presented to a selected customer 38 via a customer device 52. FIG. 17B shows an example of a customer device 52 displaying the customized offer 44, offering a customer to book an appointment between 10 am and 2 pm and receive 10% off a new set of tires, with an expiration date of Jun. 10, 2020. Thus, the customized offer 44 includes a percent-off discount and an expiration based on the promotional schedule 46, which may also be customized by the user. The customized offer 44 may have been deployed according to the promotional schedule 46 to selectable customers 38.

While the above example of the tire shop represents a service that is scheduled and may consume products (e.g. tires) associated with the service, the digital marketing automation system 12 may also accommodate a service featuring an organized activity having participation slots. Examples of such a service include exercise classes, movie theater showings, and day care sessions. Owners of businesses that provide these services may use a service promotion tool similar to the above-mentioned scheduled service tool 1600 to generate a customized offer 44. FIG. 17C shows an example of a customer device 52 displaying the customized offer 44 for a business providing childcare services, offering the customer to enroll a pre-K child in morning childcare sessions starting in July, with a 20% off discount.

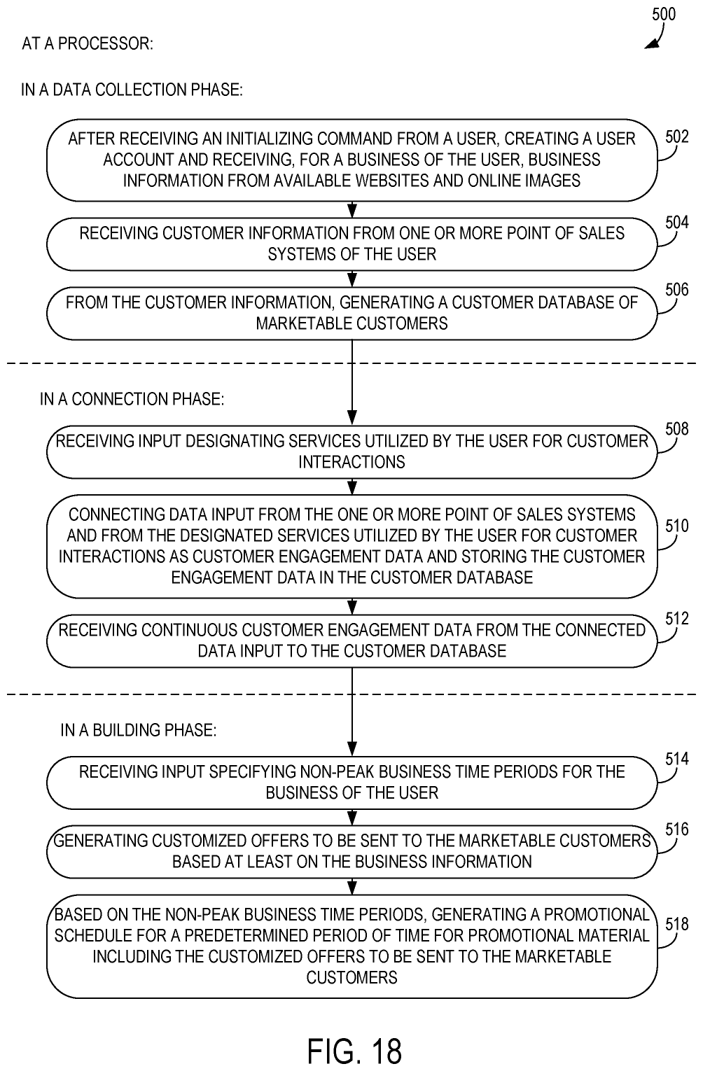

FIG. 18 shows a flowchart of a method 500 for use with a computing device of the system 12. The following description of method 500 is provided with reference to the computing systems described above. It will be appreciated that method 500 may also be performed in other contexts with other suitable components.

With reference to FIG. 18, the method 500 may be for use with a computing device including a server 14, a processor 16, and associated storage. As described above, the associated storage may include volatile memory 18 and non-volatile memory 20 as shown in FIG. 1. The processor 16 may be configured to execute instructions stored in the storage. The method 500 at 502 may include, in a data collection phase, after receiving an initializing command from a user, creating a first user account 22 and receiving, for a business of the user, business information 50 from available websites and online images. FIGS. 2 and 3 show example pages from a digital marketing automation website 24 where the user may create a first user account 22 and enter user input 28. The method 500 at 504 may include receiving customer information 35 from one or more point of sales systems 34 of the user. FIG. 7 shows an example page of the digital marketing automation website 24 where point of sales systems 34 may be designated by the user. The first user account 22 may be stored at the non-volatile memory 20 of the server 14, which may be in communication with one or more web servers 26. Business information 50 may be input from, for example, a business website 30 of the user and online images 32 available on the one or more web servers 26. Also, the customer information 35 may be extracted from the one or more point of sales systems 34 that may also be on the one or more web servers 26. At 506, the method 500 may include, from the customer information 35, generating a customer database 36 of selectable customers 38 as shown in FIG. 1. The selectable customers 38 may include customers from the one or more point of sales systems 34 that are indicated to permit or have opted in to receiving promotional materials or communications from the business of the user.

The method 500 at 508 may include, in a connection phase, receiving input designating services utilized by the user for customer interactions. The designated services utilized by the user for customer interactions may include at least one of social networking services 42, ordering services 60, and delivery services 62, which may also be accessible at the one or more web servers 26. FIG. 8 shows an example page from the digital marketing automation website 24 where a user may designate one or more services. At 510, the method 500 may include connecting data input from the one or more point of sales systems 34 and from the designated services utilized by the user for customer interactions as customer engagement data 40 and storing the customer engagement data 40 in the customer database 36. The method 500 at 512 may include receiving continuous customer engagement data 40 from the connected data input to the customer database 36. As described above, the customer engagement data 40 may include at least one of clicks on links, clicks on texts, social media activity, and business-related website activity.

The method 500 at 514 may include, in a building phase, receiving input specifying non-peak business time periods for the business of the user. As shown in FIGS. 9A-9C, the input may be entered by the user at the digital automation website 24. At 516, the method 500 may include generating customized offers 44 to be sent to the selectable customers 38 based at least on the business information 50. At 518, the method 500 may include, based on the non-peak business time periods, generating a promotional schedule 46 for a predetermined period of time 47 for promotional material 48 that may include the customized offers 44 to be sent to the selectable customers 38. The method 500 may further include, at the processor 16, receiving user input 28 to customize at least one of the promotional schedule 46, the predetermined period of time 47, the promotional material 48, and the customized offers 44. FIGS. 4-6 and 10 show example pages from the digital marketing automation website 24 where the user may customize the customized offers 44, select promotion types, and set terms and conditions. FIG. 11 shows an example page displaying an example promotional schedule 46 with customized offers 44.

The method 500 may further include, at the processor 16, in an analysis phase, from the one or more point of sales systems 34, receiving transaction data 54 and promotional material redemption data 56. The method 500 may include compiling data including the transaction data 54, the promotional material redemption data 56, and the customer engagement data 40, and outputting one or more sales metrics 58 representing customer response to the promotional material 56. FIG. 13 is an example page of the digital marketing automation website 24 showing a sample of sales metrics 58 that may be displayed to the user. As described above, the one or more sales metrics 58 representing customer response to the promotional material 48 may include at least one of return on investment 64, total number of promotional material redemptions 66, metrics representing changes in customer engagement data 68 based on the connected data input, comparisons between pre-release and post-release of the promotional material, and average number of sales.

The method 500 may further include, at the processor 16, in the analysis phase, for a plurality of user accounts that include the one or more point of sales systems 34 and from the customer engagement data 40, determining a correlation 76 between the transaction data 54 and the customer engagement data 40. For at least one user account that does not include the one or more point of sales systems 34, based on the correlation 76 and customer engagement data 40 for the at least one user account that does not include the one or more point of sales systems 34, estimated transaction data 78 may be determined. A potential advantage of this configuration is that users without one or more point of sales systems 34 may receive sales metrics 58 based on the estimated transaction data 78 instead of actual transaction data.

As discussed above, FIG. 14 shows an example of the digital marketing automation system 12 where machine learning (ML) is included for processing data and generating outputs. Thus, the method 500 may further include, at the processor 16, in a training phase, inputting to an ML algorithm 82 that may be included in an ML system 80 a training data set including at least the customer engagement data 40, the promotional schedule 46, the transaction data 54, and the promotional material redemption data 56. It will be appreciated that data pre-processing may be configured to prepare the training data set 84 or later input data for reception at the machine learning system 80. Data pre-processing may include, for example, vectorization of input data. The method 500 may include training the ML algorithm 82 to identify the one or more sales metrics 58 representing customer response to the promotional material 48. The method 500 may further include, in a runtime phase, inputting to the trained ML algorithm 82 real-time data from the one or more point of sales systems 34 including the transaction data 54 and the promotional material redemption data 56. Once the ML algorithm 82 is trained, it may function as a classifier to determine sales metrics 58. Thus, the method 500 may include outputting, from the trained ML algorithm 82, a schedule of actual non-peak business time periods 88 and one or more ML-generated sales metrics 90 representing customer response to the promotional material 48. The method 500 may further include generating, from the trained ML algorithm 82, ML-generated promotional material 92 and an ML-generated promotional schedule 94 for the ML-generated promotional material 92 to be distributed to the selectable customers 38. The output of the ML system 80 may continually receive transaction data 54, customer engagement data 40, and so forth in order to adjust the ML-generated promotional schedule 94 on an ongoing basis. The method 500 may further include, at the processor 16, in the runtime phase, inputting to the trained ML algorithm 82 the customer information 35 of the selectable customers 38, the transaction data 54, and the promotional material redemption data 56. The method 500 may include determining, at the trained ML algorithm 82, individualized selectable customer data 96 including at least customer frequency 98, and generating customer-specific promotional material 100 to be distributed on a customer-specific promotional schedule 102.

The digital marketing automation system 12 may provide users who are interested in promoting their business to customers a means to automate distribution of promotional material. Automating marketing that is customized to the interests of a particular business owner as the user of the system may both cut costs for the user who may otherwise employ a marketing firm and also keep control of marketing in the hands of the user. Incorporating machine learning techniques into the automation system 12 may be advantageous to the user in that, particularly for restauranteurs in a business environment in regular flux, transaction data and customer response may be continually measured and promotional material generated to match changes in business flow.

Hereinabove, where usage refers to a web server, website, or web page, it will be appreciated that the content described served in this manner may include content served by HTTP servers to requesting clients, whether those clients are general purpose internet browsers or stand-alone application programs executed customer devices 52. Thus, a “web server” as used herein will be understood to include an app server, and a “website” or “web page” will be understood to include dynamically generated or static content served by an app server to an application program.

In some embodiments, the methods and processes described herein may be tied to a computing system of one or more computing devices. In particular, such methods and processes may be implemented as an executable computer-application program, a network-accessible computing service, an application-programming interface (API), a library, or a combination of the above and/or other computer resources.

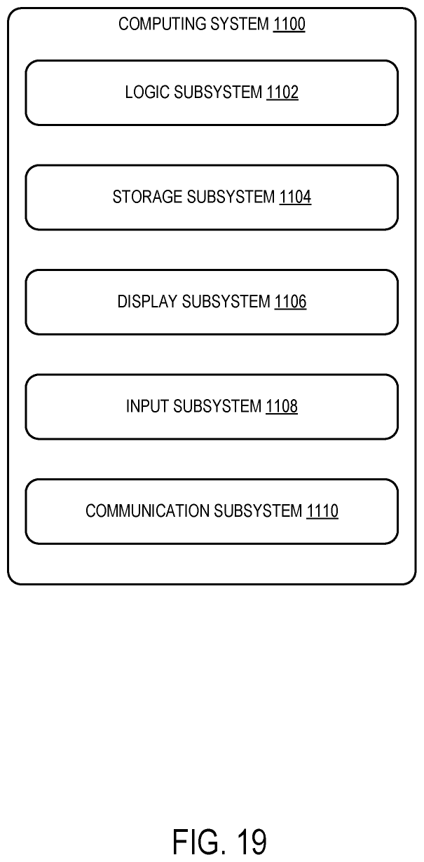

FIG. 19 schematically shows a simplified representation of a computing system 1100 configured to provide any to all of the compute functionality described herein. Computing system 1100 may take the form of one or more virtual/augmented/mixed reality computing devices, personal computers, network-accessible server computers, tablet computers, home-entertainment computers, gaming devices, mobile computing devices, mobile communication devices (e.g., smart phone), wearable computing devices, Internet of Things (IoT) devices, embedded computing devices, and/or other computing devices.

Computing system 1100 includes a logic subsystem 1102 and a storage subsystem 1104. Computing system 1100 may optionally include a display subsystem 1106, input subsystem 1108, communication subsystem 1110, and/or other subsystems not shown in FIG. 19.

Logic subsystem 1102 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 1104 includes one or more physical devices configured to temporarily and/or permanently hold computer information such as data and instructions executable by the logic subsystem. When the storage subsystem includes two or more devices, the devices may be collocated and/or remotely located. Storage subsystem 1104 may include volatile, nonvolatile, dynamic, static, read/write, read-only, random-access, sequential-access, location-addressable, file-addressable, and/or content-addressable devices. Storage subsystem 1104 may include removable and/or built-in devices. When the logic subsystem executes instructions, the state of storage subsystem 1104 may be transformed—e.g., to hold different data.

Aspects of logic subsystem 1102 and storage subsystem 1104 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

When included, display subsystem 1106 may be used to present a visual representation of data held by storage subsystem 1104. This visual representation may take the form of a graphical user interface (GUI) including holographic virtual objects. Display subsystem 1106 may include one or more display devices utilizing virtually any type of technology. In some implementations, display subsystem 1106 may include one or more virtual-, augmented-, or mixed reality displays.

When included, input subsystem 1108 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 1110 may be configured to communicatively couple computing system 1100 with one or more other computing devices. Communication subsystem 1110 may include wired and/or wireless communication devices compatible with one or more different communication protocols. The communication subsystem may be configured for communication via personal-, local- and/or wide-area networks.

The methods and processes disclosed herein may be configured to give users and/or any other humans control over any private and/or potentially sensitive data. Whenever data is stored, accessed, and/or processed, the data may be handled in accordance with privacy and/or security standards. When user data is collected, users or other stakeholders may designate how the data is to be used and/or stored. Whenever user data is collected for any purpose, the user data should only be collected with the utmost respect for user privacy (e.g., user data may be collected only when the user owning the data provides affirmative consent, and/or the user owning the data may be notified whenever the user data is collected). If the data is to be released for access by anyone other than the user or used for any decision-making process, the consent of the user may be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible anonymized, to further protect user privacy. Users may designate portions of data, metadata, or statistics/results of processing data for release to other parties, e.g., for further processing. Data that is private and/or confidential may be kept completely private, e.g., only decrypted temporarily for processing, or only decrypted for processing on a user device and otherwise stored in encrypted form. Users may hold and control encryption keys for the encrypted data. Alternately or additionally, users may designate a trusted third party to hold and control encryption keys for the encrypted data, e.g., so as to provide access to the data to the user according to a suitable authentication protocol.

When the methods and processes described herein incorporate ML and/or AI components, the ML and/or AI components may make decisions based at least partially on training of the components with regard to training data. Accordingly, the ML and/or AI components can and should be trained on diverse, representative datasets that include sufficient relevant data for diverse users and/or populations of users. In particular, training data sets should be inclusive with regard to different human individuals and groups, so that as ML and/or AI components are trained, their performance is improved with regard to the user experience of the users and/or populations of users.

ML and/or AI components may additionally be trained to make decisions so as to minimize potential bias towards human individuals and/or groups. For example, when AI systems are used to assess any qualitative and/or quantitative information about human individuals or groups, they may be trained so as to be invariant to differences between the individuals or groups that are not intended to be measured by the qualitative and/or quantitative assessment, e.g., so that any decisions are not influenced in an unintended fashion by differences among individuals and groups.

ML and/or AI components may be designed to provide context as to how they operate, so that implementers of ML and/or AI systems can be accountable for decisions/assessments made by the systems. For example, ML and/or AI systems may be configured for replicable behavior, e.g., when they make pseudo-random decisions, random seeds may be used and recorded to enable replicating the decisions later. As another example, data used for training and/or testing ML and/or AI systems may be curated and maintained to facilitate future investigation of the behavior of the ML and/or AI systems with regard to the data. Furthermore, ML and/or AI systems may be continually monitored to identify potential bias, errors, and/or unintended outcomes.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. If used herein, a phrase of the form “at least one of A and B” means at least one A or at least one B, without being mutually exclusive of each other, and does not require at least one A and at least one B. If used herein, the phrase “and/or” means any or all of multiple stated possibilities.

The subject matter of the present disclosure includes all novel and non-obvious combinations and sub-combinations of the various processes, systems and configurations, and other features, functions, acts, and/or properties disclosed herein, as well as any and all equivalents thereof.

1. A digital marketing automation system, the system comprising:
a server including a processor and associated storage, the processor being configured to execute instructions stored in the associated storage to:
in a data collection phase:
after receiving an initializing command from a user, create a user account and receive, for a business of the user, business information from available websites and online images;
receive customer information from one or more point of sales systems of the user; and
from the customer information, generate a customer database of selectable customers;
in a connection phase:
receive input designating services utilized by the user for customer interactions;
connect data input from the one or more point of sales systems and from the designated services utilized by the user for customer interactions as customer engagement data and store the customer engagement data in the customer database; and
receive continuous customer engagement data from the connected data input to the customer database;
in a building phase:
receive input specifying at least one available product or service of the business of the user;
generate customized offers to be sent to the selectable customers based at least on the business information; and
based on the at least one available product or service, generate a promotional schedule for a predetermined period of time for promotional material including the customized offers to be sent to the selectable customers.

2. The system of claim 1, the processor further configured to:
in an analysis phase:
from the one or more point of sales systems, receive transaction data and promotional material redemption data;
compile data including the transaction data, the promotional material redemption data, and the customer engagement data; and
output one or more sales metrics representing customer response to the promotional material.

3. The system of claim 2, wherein the at least one available product or service is available during a redemption period during which the product or service is available at a location; and
the processor is further configured to:
in a training phase:
input to a machine learning (ML) algorithm a training data set including at least the customer engagement data, the promotional schedule, the transaction data, and the promotional material redemption data; and
train the ML algorithm to identify the one or more sales metrics representing customer response to the promotional material;
in a runtime phase:
input to the trained ML algorithm real-time data from the one or more point of sales systems including the transaction data and the promotional material redemption data;
output, via the trained ML algorithm, the redemption period of the promotion for the product or service and one or more ML-generated sales metrics representing customer response to the promotional material; and
generate, via the trained ML algorithm, ML-generated promotional material and an ML-generated promotional schedule for the ML-generated promotional material to be distributed to the selectable customers.

4. The system of claim 3, the processor further configured to:
in the runtime phase:
input to the trained ML algorithm the customer information of the selectable customers, the transaction data, and the promotional material redemption data;
determine, via the trained ML algorithm, individualized selectable customer data including at least customer frequency; and
generate customer-specific promotional material to be distributed on a customer-specific promotional schedule.

5. The system of claim 2, wherein the one or more sales metrics representing customer response to the promotional material include at least one of return on investment, total number of promotional material redemptions, metrics representing changes in customer engagement data based on the connected data input, comparisons between pre-release and post-release of the promotional material, and average number of sales.

6. The system of claim 2, the processor further configured to:
in the analysis phase:
for a plurality of user accounts that include the one or more point of sales systems and from the customer engagement data, determine a correlation between the transaction data and the customer engagement data; and
for at least one user account that does not include the one or more point of sales systems, based on the correlation and customer engagement data for the at least one user account that does not include the one or more point of sales systems, determine estimated transaction data.

7. The system of claim 1, wherein the customer engagement data includes at least one of clicks on links, clicks on texts, social media activity, and business-related website activity.

8. The system of claim 1, wherein the designated services utilized by the user for customer interactions include at least one of social networking services, ordering services, and delivery services.

9. The system of claim 1, wherein the user selects, from a collection of pre-built offers included in the system, preferred pre-built offers, and the generation of customized offers is based at least on the business information and the user selection of preferred pre-built offers.

10. The system of claim 1, the processor further configured to receive user input to customize at least one of the promotional schedule, the predetermined period of time, the promotional material, and the customized offers.

11. A method for use with a computing device including a server, a processor, and associated storage, the processor being configured to execute instructions stored in the storage, the method comprising:
at the processor:
in a data collection phase:
after receiving an initializing command from a user, creating a user account and receiving, for a business of the user, business information from available websites and online images;
receiving customer information from one or more point of sales systems of the user; and
from the customer information, generating a customer database of selectable customers;
in a connection phase:
receiving input designating services utilized by the user for customer interactions;
connecting data input from the one or more point of sales systems and from the designated services utilized by the user for customer interactions as customer engagement data and storing the customer engagement data in the customer database; and
receiving continuous customer engagement data from the connected data input to the customer database;
in a building phase:
receiving input specifying non-peak business time periods for the business of the user;
generating customized offers to be sent to the selectable customers based at least on the business information; and
based on the non-peak business time periods, generating a promotional schedule for a predetermined period of time for promotional material including the customized offers to be sent to the selectable customers.

12. The method of claim 11, the method further comprising, at the processor:
in an analysis phase:
from the one or more point of sales systems, receiving transaction data and promotional material redemption data;
compiling data including the transaction data, the promotional material redemption data, and the customer engagement data; and
outputting one or more sales metrics representing customer response to the promotional material.

13. The method of claim 12, the method further comprising, at the processor:
in a training phase:
inputting to a machine learning (ML) algorithm a training data set including at least the customer engagement data, the promotional schedule, the transaction data, and the promotional material redemption data; and
training the ML algorithm to identify the one or more sales metrics representing customer response to the promotional material;
in a runtime phase:
inputting to the trained ML algorithm real-time data from the one or more point of sales systems including the transaction data and the promotional material redemption data;
outputting, via the trained ML algorithm, a schedule of actual non-peak business time periods and one or more ML-generated sales metrics representing customer response to the promotional material; and
generating, via the trained ML algorithm, ML-generated promotional material and an ML-generated promotional schedule for the ML-generated promotional material to be distributed to the selectable customers.

14. The method of claim 13, the method further comprising, at the processor:
in the runtime phase:
inputting to the trained ML algorithm the customer information of the selectable customers, the transaction data, and the promotional material redemption data;
determining, via the trained ML algorithm, individualized selectable customer data including at least customer frequency; and
generating customer-specific promotional material to be distributed on a customer-specific promotional schedule.

15. The method of claim 12, wherein the one or more sales metrics representing customer response to the promotional material include at least one of return on investment, total number of promotional material redemptions, metrics representing changes in customer engagement data based on the connected data input, comparisons between pre-release and post-release of the promotional material, and average number of sales.

16. The method of claim 12, the method further comprising, at the processor:
in the analysis phase:
for a plurality of user accounts that include the one or more point of sales systems and from the customer engagement data, determining a correlation between the transaction data and the customer engagement data; and
for at least one user account that does not include the one or more point of sales systems, based on the correlation and customer engagement data for the at least one user account that does not include the one or more point of sales systems, determining estimated transaction data.

17. The method of claim 11, wherein the customer engagement data includes at least one of clicks on links, clicks on texts, social media activity, and business-related website activity.

18. The method of claim 11, wherein the designated services utilized by the user for customer interactions include at least one of social networking services, ordering services, and delivery services.

19. The method of claim 11, the method further comprising, at the processor:
receiving user input to customize at least one of the promotional schedule, the predetermined period of time, the promotional material, and the customized offers.

20. A digital marketing automation system, the system comprising:
a server including a processor and associated storage, the processor being configured to execute instructions stored in the associated storage to:
in a data collection phase:
after receiving an initializing command from a user, create a user account and receive, for a business of the user, business information from available websites and online images;
receive customer information from one or more point of sales systems of the user; and
from the customer information, generate a customer database of selectable customers;
in a connection phase:
receive input designating services utilized by the user for customer interactions;
connect data input from the one or more point of sales systems and from the designated services utilized by the user for customer interactions as customer engagement data and store the customer engagement data in the customer database; and
receive continuous customer engagement data from the connected data input to the customer database;
in a building phase:
receive input specifying non-peak business time periods for the business of the user;
generate customized offers to be sent to the selectable customers based at least on the business information; and
based on the non-peak business time periods, generate a promotional schedule for a predetermined period of time for promotional material including the customized offers to be sent to the selectable customers;
in an analysis phase:
from the one or more point of sales systems, receive transaction data and promotional material redemption data;
compile data including the transaction data, the promotional material redemption data, and the customer engagement data; and
output one or more sales metrics representing customer response to the promotional material, wherein
the customer engagement data includes at least one of clicks on links, clicks on texts, social media activity, and business-related website activity, and
the designated services utilized by the user for customer interactions include at least one of social networking services, ordering services, and delivery services.

21. The system of claim 1, wherein the at least one available product or service is offered at a plurality of locations.

22. The system of claim 21, wherein the processor is further configured to:
receive input specifying at least one target location of the plurality of locations where the customized offers are eligible for redemption.

23. The system of claim 22, wherein an availability of the available product or service at the at least one target location is indicated by an inventory management system, and wherein when the inventory management system indicates that the availability of the product or service drops below a predetermined threshold, the processor is configured to cease sending the customized offers.

24. The system of claim 21, wherein the available product or service is selected from the group consisting of a service that is scheduled, a service featuring an organized activity having participation slots, a product that is stored in inventory, and a product that is prepared on site.

25. The system of claim 21, varying the promotion type, promotional schedule, target product or service, and/or redeemable location of the customized offer based upon feedback collected from engagement, redemption, and transaction data for previously presented offers.
